(19) United States
(12) Patent Application Publication
(10) Pub. No.: US 2026/0179012 A1
(43) Pub. Date: Jun. 25, 2026

(54) MANAGEMENT DEVICE, MOLDING MACHINE, AND MOLDING SYSTEM

(71) Applicant: SUMITOMO HEAVY INDUSTRIES, LTD., Tokyo (JP)

(72) Inventors: Daigo HOTTA, Chiba-shi (JP); Tomosuke KADOONO, Chiba-shi (JP); Atsuro TAMURA, Chiba-shi (JP)

(21) Appl. No.: 19/311,569

(22) Filed: Aug. 27, 2025

(30) Foreign Application Priority Data
Dec. 20, 2024 (JP) 2024-225524

(51) Int. Cl. G06Q 10/0631

(52) U.S. Cl. CPC G06Q 10/06315; G06Q 10/063112

(57) ABSTRACT

A management device includes: a management unit that manages a user who uses a molding device by using a first management method of managing a level of the user based on a role and a second management method of managing the level of the user based on a skill level of work.

### CROSS-REFERENCE TO RELATED APPLICATIONS

This application claims priority to Japanese Patent Application No. 2024-225524, filed on Dec. 20, 2024, which is incorporated by reference herein in its entirety.

### BACKGROUND

### Technical Field

Certain embodiments of the present invention relate to a management device, a molding machine, and a molding system.

### Description of Related Art

The related art describes a molding machine in which users are grouped according to job roles (administrator, worker, and the like) and only operation authority according to the job roles is granted to each group.

The related art describes an injection molding machine including a touch panel, in which an access level that allows or prohibits display is set for all screens that can be displayed on the touch panel, and display is restricted according to the authority of an operator.

### SUMMARY

According to an embodiment of the present invention, there is provided a management device including management means that manages a user who uses a molding device by using a first management method of managing a level of the user based on a role and a second management method of managing the level of the user based on a skill level of work.

### BRIEF DESCRIPTION OF THE DRAWINGS

FIG. 1 is a view showing a configuration of an injection molding machine to which one embodiment is applied.

FIG. 2 is a view showing a configuration of a control device.

FIG. 3 is a view showing a configuration of a data processing device.

FIG. 4 is a view showing a configuration of a management device.

FIG. 5 is a view showing a hardware configuration example of a computer that realizes a control device, a data processing device, and a management device.

FIGS. 6A and 6B are diagrams showing an example of setting a level of a user, FIG. 6A shows an example in which a level is set based on a role, and FIG. 6B shows an example in which a level is set based on a skill level of the work.

FIG. 7 is a diagram showing an example of a table in which identification information of a user and a level of the user are associated with each other.

FIG. 8 is a flowchart showing an example of a flow of processing in a case where information is provided to a user who uses an injection molding machine.

FIG. 9 is a diagram showing an example of a table in which identification information of a user and a level for each work process of the user are associated with each other.

### DETAILED DESCRIPTION

In the molding machine, information to be provided may be different depending on the role of the user. For example, in a case where there are functions that can be used and functions that cannot be used depending on the role of the user, only information about the functions that can be used may be provided to the user. However, necessary information may be different depending on a skill level of a user in performing the work, for example, regardless of the role of the user. Even in such a case, it is preferable to manage the user so that the user can be provided with necessary information.

It is desirable to provide a management device or the like that manages a user so that information can be more appropriately provided to the user, as compared with a case where the user is managed according to a role.

Hereinafter, an embodiment of the present invention will be described in detail with reference to the accompanying drawings.

### One Embodiment

### Device Configuration

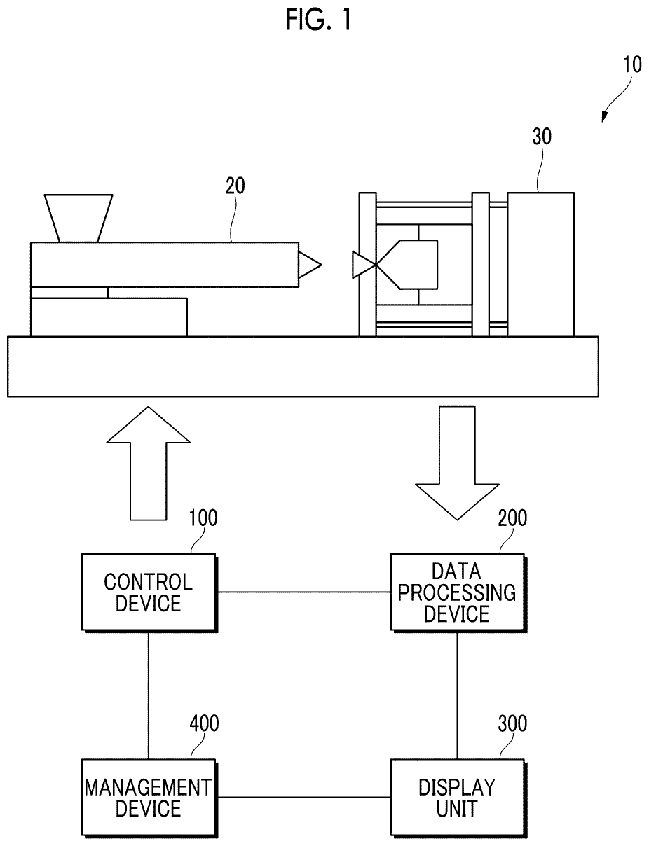

FIG. 1 is a view showing a configuration of an injection molding machine 10 to which one embodiment is applied. The injection molding machine 10 includes an injection unit 20, a mold clamping unit 30, a control device 100, a data processing device 200, a display unit 300, and a management device 400. In the following description, a direction from the injection unit 20 toward the mold clamping unit 30 may be referred to as a front. The injection molding machine 10 is an example of a molding machine. The injection unit 20 and the mold clamping unit 30 are examples of a molding device.

The injection unit 20 is configured with a cylinder that heats a molding material, a screw that is rotatable in the cylinder and that is capable of advancing and retreating in an axial direction, a rotary motor that drives the screw in a rotation direction, a motor that drives the screw in the axial direction, and the like. The molding material is, for example, a resin. The injection unit 20 injects the molding material that is heated and liquefied in the cylinder by advancing the screw in a front direction while rotating the screw, and fills a mold of the mold clamping unit 30 disposed in front of the injection unit 20. The injection unit 20 performs, for example, a plasticizing process, a filling process, a pressure holding process, or the like in a manufacturing process of a molding product. The filling process and the pressure holding process may be collectively referred to as an injection process.

The mold clamping unit 30 includes the mold, a clamping mechanism that clamps the mold, a motor that drives the clamping mechanism, and the like. The mold clamping unit 30 closes the mold to receive the molding material injected from the injection unit 20 into an inside of the mold. In this case, the mold clamping unit 30 clamps the mold by means of a clamping mechanism such that the mold does not open due to the filling of the molding material (mold clamping). A molding product is produced by solidifying the molding material filled in the mold. After that, the mold clamping unit 30 opens the mold and ejects the produced molding product. The mold clamping unit 30 performs, for example, a mold closing process, a pressure increasing process, a mold clamping process, a depressurizing process, a mold opening process, or the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 operate. The display unit 300 displays information related to the control of the injection unit 20 and the mold clamping unit 30 by the control device 100, data acquired by the data processing device 200, a processing result of the data processing device 200, and the like. In addition, the display unit 300 displays an operation screen for performing an operation to input commands or data to the control device 100 and the data processing device 200. In addition, the display unit 300 displays information of advice provided to a user. The management device 400 is a device that manages a level of a user who uses the injection molding machine 10. The level of the user managed by the management device 400 is used, for example, to determine functions and information of advice to be provided to the user.

### Configuration of Control Device 100

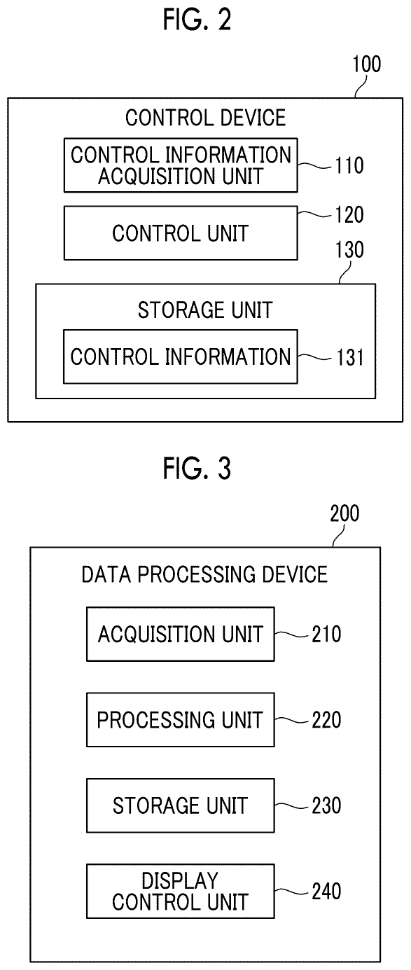

FIG. 2 is a view showing a configuration of the control device 100. The control device 100 controls operations of the injection unit 20 and the mold clamping unit 30. The control device 100 is realized by, for example, a computer. The control device 100 includes a control information acquisition unit 110, a control unit 120, and a storage unit 130. The control device 100 controls the injection unit 20 and the mold clamping unit 30 to repeatedly perform a process related to the manufacturing of the molding product, thereby repeatedly manufacturing the molding product. The process related to the manufacturing of the molding product includes a plasticizing process, a mold closing process, a pressure increasing process, a mold clamping process, a filling process, a pressure holding process, a cooling process, a depressurizing process, a mold opening process, an ejection process, and the like. Hereinafter, these processes related to the manufacturing may be collectively referred to as a “manufacturing process”. In addition, a series of operations for obtaining a molding product, for example, an operation from the start of the plasticizing process in the above manufacturing process to the start of the next plasticizing process is referred to as a “shot”, a “molding cycle”, or the like. In addition, each of the above processes for manufacturing the molding product is merely an example. For example, as a process executed in one shot, another process not included in the above may be included.

The control information acquisition unit 110 acquires control information used to control the injection unit 20 and the mold clamping unit 30. The control information is a condition set by the user, and, for example, is input by the user using an input unit (not shown). For example, the control information includes molding conditions such as a resin temperature, a mold temperature (a cylinder temperature), an injection pressure holding time, a metering value, a V-P switching position, a pressure holding, an injection speed (a filling speed), a screw rotation speed, a screw back pressure, and a mold clamping force. A plurality of combinations of these molding conditions are determined depending on the molding product and the mold. Hereinafter, the combination data of the molding conditions will be also referred to as a molding condition data set. The control information acquisition unit 110 stores the acquired control information in the storage unit 130 as the molding condition data set.

The control unit 120 controls the injection unit 20 and the mold clamping unit 30 by using the above molding condition data set, and performs a process related to the manufacturing (shot) of the molding product including each of the above processes. The control unit 120 reads a molding condition data set corresponding to the molding product to be manufactured from the storage unit 130, for example, in a case where the manufacturing of the molding product starts. Then, the control unit 120 controls the operations of the injection unit 20 and the mold clamping unit 30 based on the read control information. Specifically, the control unit 120 controls the injection unit 20 and the mold clamping unit 30 such that the data obtained from the injection unit 20 and the mold clamping unit 30 in the manufacturing process matches a setting value of the molding condition data set. In addition, the control unit 120 may cause the display unit 300 to display the molding condition data set read from the storage unit 130. The user may refer to the data of the molding conditions displayed on the display unit 300 and may perform an operation such as correcting a value as necessary.

The storage unit 130 holds control information 131 acquired by the control information acquisition unit 110. The molding condition data set included in the control information 131 is prepared in association with a molding product to be manufactured and the mold. The storage unit 130 holds a molding condition data set for each molding product to be manufactured and each mold. In addition, although not shown, the storage unit 130 holds a program for the control unit 120 to control the injection unit 20 and the mold clamping unit 30. As will be described in detail later, the function of the control unit 120 is realized by a processor of the control device 100 reading and executing the program held in the storage unit 130.

### Configuration of Data Processing Device 200

FIG. 3 is a view showing a configuration of the data processing device 200. The data processing device 200 acquires and processes data obtained as the injection unit 20 and the mold clamping unit 30 execute operations in the process related to the manufacturing of the molding product. The data processing device 200 is realized by, for example, a computer. The data processing device 200 includes an acquisition unit 210, a processing unit 220, a storage unit 230, and a display control unit 240.

The acquisition unit 210 acquires data to be processed from the injection unit 20 and the mold clamping unit 30. Various sensors and detectors are attached to the injection unit 20 and the mold clamping unit 30. The data acquired by the sensors and the detectors (hereinafter, referred to as “acquisition data”) is information representing a molding result of the injection unit 20 and the mold clamping unit 30, and is used for quality control of the molding product. Specifically, for example, the weight of the molding product, the dimensions of the molding product, the mold internal pressure, the minimum cushion position, and the feature values of the waveform of the filling pressure are included. The acquisition data is an actual value obtained in a manufacturing process of the molding product. The acquisition unit 210 receives the acquisition data transmitted from the sensor and the detector and stores the acquisition data in the storage unit 230.

The processing unit 220 processes the acquisition data stored in the storage unit 230. Specifically, the processing unit 220 performs processing of extracting a representative value of the acquisition data in each process and processing of generating time series data in which the acquisition data in each process is arranged in chronological order. In extracting the representative value, the processing unit 220 performs statistical processing such as calculating an average value, specifying a range of values, and specifying a maximum value or a minimum value on the acquisition data.

The storage unit 230 holds the representative value, the time series data, the statistical data, and the like, processed by the processing unit 220. The data is associated with, for example, the original acquisition data. Specifically, the data may be stored in a data file of the original acquisition data corresponding to the data. In addition, the data file in which data is stored may be associated with the data file of the original data. Accordingly, each piece of data generated by the processing unit 220 is also held in association with the molding product to be manufactured and the mold in the shot in which the original acquisition data is obtained. As the data format of the data file held in the storage unit 230, for example, comma-separated values (CSV), Extensible Markup Language (XML), JavaScript Object Notation (JSON), or the like can be used.

In addition, although not shown, the storage unit 230 holds a program for the processing unit 220 to execute data processing. As will be described in detail later, the processor of the data processing device 200 reads and executes the program held in the storage unit 230, so that functions of the processing unit 220 are realized.

The display control unit 240 causes the display unit 300 to display the acquisition data and the data of the processing result by the processing unit 220. The data to be displayed includes setting information in the control information used by the control device 100 to control the injection unit 20 and the mold clamping unit 30. The setting information (setting value) can be acquired from the control device 100. The display control unit 240 acquires the data from the storage unit 230 and the storage unit 130 of the control device 100 and causes the data to be displayed on the display unit 300.

### Configuration of Management Device 400

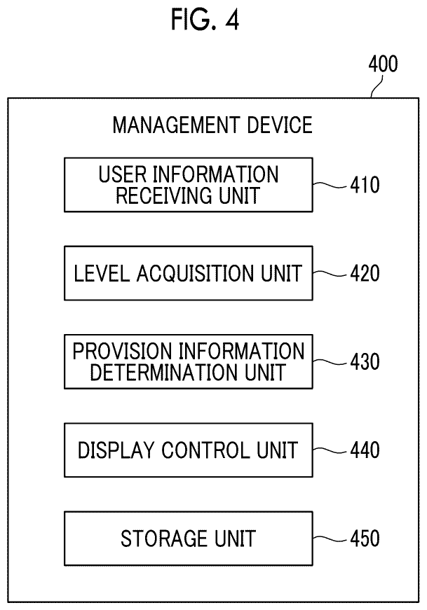

FIG. 4 is a view showing a configuration of the management device 400. The management device 400 includes a user information receiving unit 410, a level acquisition unit 420, a provision information determination unit 430, a display control unit 440, and a storage unit 450. The management device 400 is an example of management means.

The user information receiving unit 410 acquires identification information of the user who uses the injection molding machine 10. For example, the user is managed by being assigned identification information such as an ID and a password for each individual or group to which the user belongs. The identification information of the user is stored in the storage unit 450 in association with a level of the user. For example, the user information receiving unit 410 acquires the ID of the user by using radio frequency identification (RFID). In addition, the ID of the user may be acquired by password input, a USB authentication key, a biometric authentication, or other methods.

The level acquisition unit 420 acquires the level of the user associated with the identification information of the user acquired by the user information receiving unit 410 from the storage unit 450.

The provision information determination unit 430 determines the information to be provided to the user. The provision information determination unit 430 determines the information to be provided to the user, based on the level of the user acquired by the level acquisition unit 420. Here, the information provided to the user is, for example, information on a function that is available to the user. In addition, for example, the information is information of advice to be provided regarding a function that is available to both a user having a relatively high skill level in the work and a user having a relatively low skill level in the work. The provision information determination unit 430 changes the information of the advice to be provided according to the level of the user.

The display control unit 440 causes the display unit 300 to display the information to be provided to the user determined by the provision information determination unit 430. The information to be provided to the user may be displayed on the display unit 300, for example, in a pop-up manner, or the information may be displayed according to a user's selection. In addition, the information to be provided to the user may be displayed on a display screen other than the display unit 300. For example, the information to be provided to the user may be transmitted to a terminal possessed by the user and may be configured to be displayed on the terminal.

The storage unit 450 stores the identification information of the user in association with the level of the user. The level of the user includes a level based on a role and a level based on a skill level of the work. The level based on the role is a level such as a level determined according to a job title or a process for which the user is responsible. The level based on the skill level of the work is a level indicating the degree of skill and understanding of the user in the work to be performed. The storage unit 450 may store the level of the user based on other parameters such as the role or the skill level of the work.

The level based on the skill level of the work may be managed by being associated with one level for each user, and the level based on the skill level of the work may be managed for each work process.

The level of the user is determined and managed based on, for example, the skill level of the work related to the setting of the molding conditions. For example, the level of the user is determined and managed based on a time required for setting the molding conditions or a screen to be checked when the molding conditions are set.

In addition, the level of the user may be managed based on the skill level of the work related to the maintenance of the injection molding machine 10, the skill level of the work related to the setup of the injection molding machine 10, and the like. For example, the level of the user is determined and managed based on a time required for the maintenance of the injection molding machine 10, a screen to be checked during the maintenance, and the like. In addition, for example, the level is determined and managed based on a time required for the setup of the injection molding machine 10, a screen to be checked during the setup, and the like.

In addition, the storage unit 450 stores provision information for each level of the user. For example, the storage unit 450 stores the level of the user and operation authority in association with each other. The provision information determination unit 430 acquires the operation authority of the user from the level of the user, and determines information to be provided to the user based on the operation authority.

In addition, for example, the storage unit 450 stores the level of the user in association with information of advice to be provided regarding a function that is available to both a user having a relatively high skill level in the work and a user having a relatively low skill level in the work. The provision information determination unit 430 acquires information of advice corresponding to the level of the user, and determines the information to be provided to the user.

### Hardware Configuration of Computer Realizing Control Device 100, Data Processing Device 200, and Management Device 400

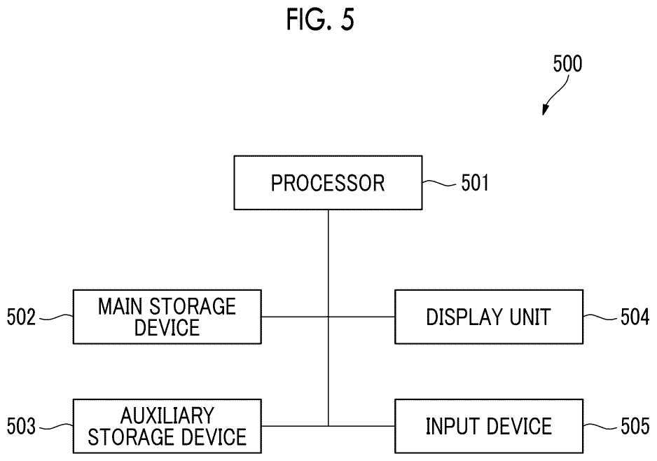

FIG. 5 is a view showing a hardware configuration example of a computer 500 that realizes the control device 100, the data processing device 200, and the management device 400. The computer 500 shown in FIG. 5 includes a processor 501 serving as a calculation means, and a main storage device (main memory) 502 and an auxiliary storage device 503 serving as storage means. As the processor 501, for example, various calculation circuits such as a central processing unit (CPU), a graphics processing unit (GPU), an application-specific integrated circuit (ASIC), and a field-programmable gate array (FPGA) are used. The processor 501 reads a program stored in the auxiliary storage device 503 into the main storage device 502 and executes the program. For example, a random-access memory (RAM) is used as the main storage device 502. For example, a magnetic disk device, a solid-state drive (SSD), or the like is used as the auxiliary storage device 503.

In addition, the computer 500 includes a display unit (display) 504 and an input unit 505 through which a user performs an input operation. For example, a keyboard, a mouse, or the like is used as the input unit 505. Further, a touch panel configured integrally with the display unit 504 may be used as the input unit 505. The display unit 504 may be realized by the display unit 300 shown in FIG. 1. In addition, a configuration of the computer 500 shown in FIG. 5 is merely an example, and the computer 500 used in one embodiment is not limited to the configuration example of FIG. 5. For example, the configuration may include a non-volatile memory such as a flash memory, or a read-only memory (ROM) may be provided as the storage device.

In a case where the control device 100 is realized by the computer shown in FIG. 5, the control information acquisition unit 110 is realized by, for example, the processor 501 that reads and executes the program and the input unit 505. The function of the control unit 120 is realized, for example, by the processor 501 reading and executing the program. The storage unit 130 is realized by, for example, the auxiliary storage device 503.

In a case where the data processing device 200 is realized by the computer shown in FIG. 5, the functions of the acquisition unit 210 and the processing unit 220 are realized by, for example, the processor 501 reading and executing the program. The storage unit 230 is realized by, for example, the auxiliary storage device 503. The display control unit 240 is realized by the processor 501 that reads and executes the program.

In a case where the management device 400 is realized by the computer 500 shown in FIG. 5, the functions of the user information receiving unit 410, the level acquisition unit 420, the provision information determination unit 430, and the display control unit 440 are realized, for example, by the processor 501 reading and executing the program. The storage unit 450 is realized by, for example, the auxiliary storage device 503.

### Level Management

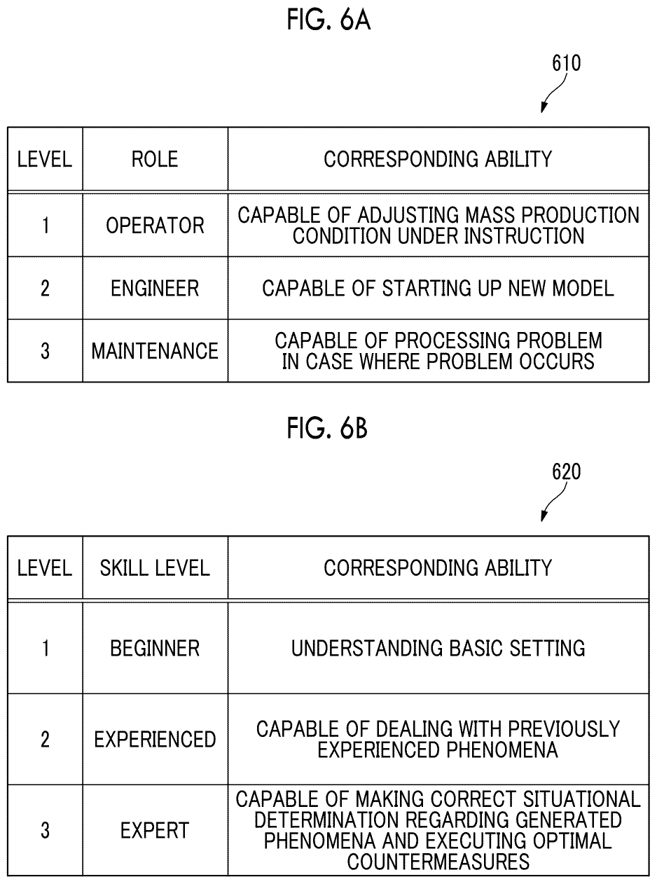

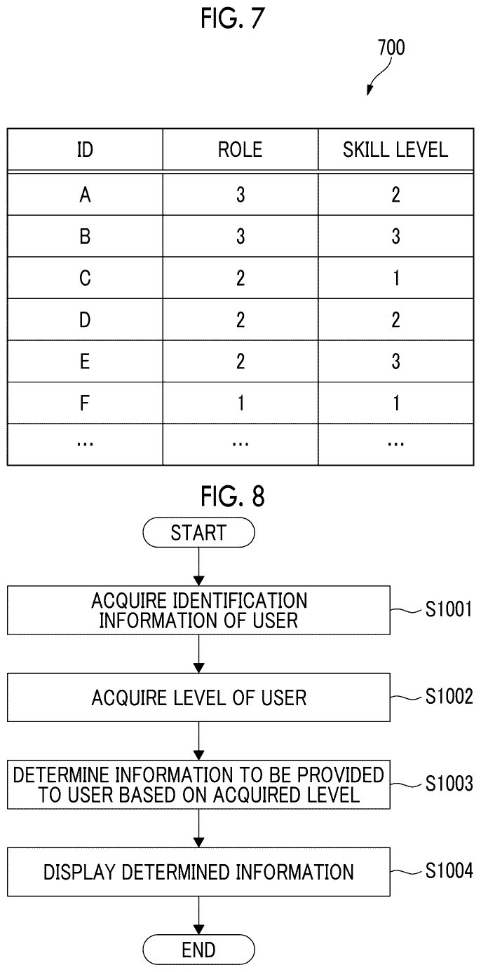

A method for managing a level of a user in one embodiment will be described with reference to FIGS. 6A to 7. A table 610, a table 620, and a table 700 shown in FIGS. 6A to 7 are stored in the storage unit 450.

FIGS. 6A and 6B are diagrams showing an example of setting a level of a user, FIG. 6A shows an example in which a level is set based on a role, and FIG. 6B shows an example in which a level is set based on a skill level of the work.

FIG. 6A is a diagram showing setting of a level based on a role of the user. The table 610 shown in FIG. 6A is a table in which the level, the role of the user, and a corresponding ability are associated with each other. In a case where the role of the user is “operator”, the level of the user is “1”, and the corresponding ability is “capable of adjusting mass production condition under instruction”. In a case where the role of the user is “engineer”, the level of the user is “2”, and the corresponding ability is “capable of starting up a new model”. In a case where the role of the user is “maintenance”, the level of the user is “3”, and the corresponding ability is “capable of processing a problem in a case where a problem occurs”.

FIG. 6B is a diagram showing setting of a level based on a skill level of the user in performing the work. The table 620 shown in FIG. 6B is a table in which the level, the skill level of the user in performing the work, and a corresponding ability are associated with each other. In a case where the skill level of the user is “beginner”, the level of the user is “1”, and the corresponding ability is “understands basic setting”. In a case where the skill level of the user is “experienced”, the level of the user is “2”, and the corresponding ability is “capable of dealing with previously experienced phenomena”. In a case where the skill level of the user is “expert”, the level of the user is “3”, and the corresponding ability is “capable of making a correct situational determination regarding generated phenomena and executing optimal countermeasures”. The level allocation and the corresponding abilities shown in FIGS. 6A and 6B may be changed by the user as appropriate.

FIG. 7 is a diagram showing an example of the table 700 in which identification information of a user and a level of the user are associated with each other. The table 700 is a table in which the ID of the user, the level based on the role, and the level based on the skill level of the work are associated with each other. For example, a user with the ID “A” has a level based on a role of “3” and a level based on a skill level of the work of “2”. From the correspondence between the table 610 and the table 620 shown in FIGS. 6A and 6B, the role of the user with the ID “A” is “maintenance”, and the skill level of the work is “experienced”.

In this way, in one embodiment, the user is managed by a first management method of managing the level of the user based on the role and a second management method of managing the level of the user based on the skill level of the work. Accordingly, it is possible to provide the user with necessary functions that differ depending on the role and necessary information that differs depending on the skill level of the work, which results from the difference in experience and the like.

The table 700 may not be stored in the storage unit 450, and may be stored in the RFID such as a card possessed by each user.

### Flow of Information Provision Processing

FIG. 8 is a flowchart showing an example of a flow of processing in a case where information is provided to a user who uses the injection molding machine 10.

In FIG. 8, first, the user information receiving unit 410 acquires identification information of the user (Step S1001). Here, it is assumed that the user information receiving unit 410 acquires the ID “A” of the user by using radio frequency identification (RFID) (see FIG. 7).

Next, the level acquisition unit 420 acquires the level of the user from the storage unit 450 (Step S1002). The level acquisition unit 420 acquires, from the table 700 stored in the storage unit 450, that the user with the ID “A” has a level based on the role of “3” and a level based on the skill level of the work of “2” (see FIG. 7).

Next, the provision information determination unit 430 determines the information to be provided to the user, based on the level acquired by the level acquisition unit 420 (Step S1003). The provision information determination unit 430 acquires the provision information for each level stored in the storage unit 450, and determines the information to be provided to the user. For example, the provision information determination unit 430 acquires the operation authority of the user based on the level according to the role, and determines the information to be provided to the user based on the operation authority. In addition, based on the level according to the skill level of the work, for example, the information to be provided is determined as information of advice to be provided regarding a function that is available to both a user having a relatively high skill level in the work and a user having a relatively low skill level in the work. As described above, the level based on the skill level of the work is used as an index for determining the information of the advice to be provided to the user.

Then, the display control unit 440 causes the display unit 300 to display the determined information (Step S1004).

In one embodiment, the level of the user managed by the management device 400 is used as an index for determining the information to be provided to the user. However, the present invention is not limited thereto. The level of the user managed by the management device 400 may be used for other purposes.

### Another Embodiment

An injection molding machine 10 according to another embodiment includes an injection unit 20, a mold clamping unit 30, a control device 100, a data processing device 200, a display unit 300, and a management device 400, as in one embodiment. In addition, the management device 400 includes a user information receiving unit 410, a level acquisition unit 420, a provision information determination unit 430, a display control unit 440, and a storage unit 450, as in one embodiment.

In another embodiment, the level of the user is managed for each work process in the storage unit 450, which is different from one embodiment. In the following, the same configuration as that of one embodiment will be described with the same reference numerals, and detailed description thereof will be omitted.

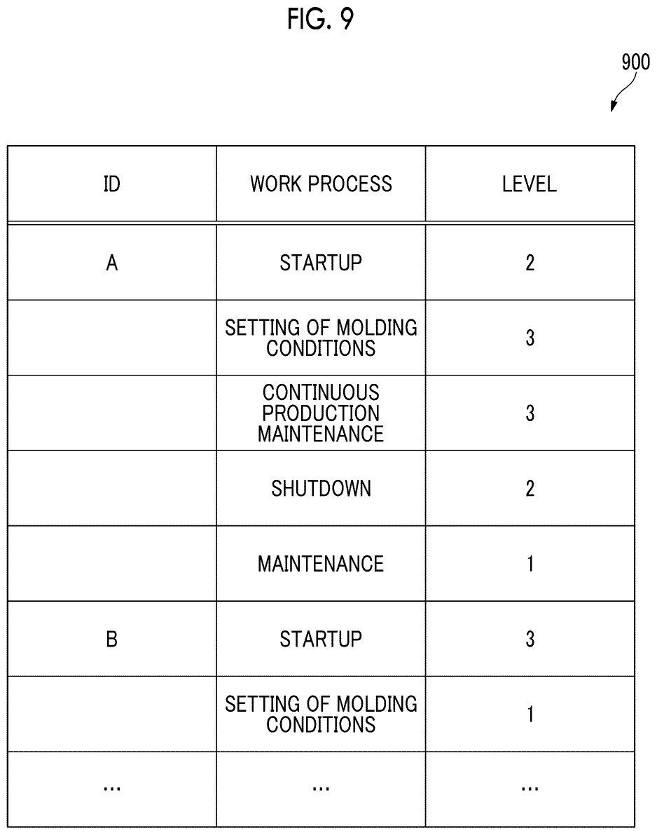

FIG. 9 is a diagram showing an example of a table 900 in which identification information of a user and a level for each work process of the user are associated with each other. The table 900 is stored in the storage unit 450.

The table 900 is a table in which the ID of the user, the work process, and the level of the user are associated with each other. In the example shown in FIG. 9, the user with the ID “A” has a level of “2” for the work process “startup” and a level of “3” for the work process “setting of molding conditions”. In addition, the user with the ID “B” has a level of “3” for the work process “startup” and a level of “1” for the work process “setting of molding conditions”.

The level may be a level based on the role or a level based on the skill level of the work. In addition, in a case where the level is managed by a plurality of parameters, the management method may be different for each parameter. For example, a configuration in which a level based on a role is not managed for each work process, and a level based on a skill level of work is managed for each work process may be adopted.

In another embodiment, the processing of providing information to the user is performed in accordance with the flow shown in FIG. 8 in the same manner as in one embodiment. Here, in another embodiment, the level of the user is managed for each work process. Therefore, the level of the user may be different for each work process, and in Step S1003, the provision information determination unit 430 determines the information to be provided to the user, based on the level for each work process.

In this way, in another embodiment, the level of the user is associated with the work process. Accordingly, for example, information tailored to the level of the user can be provided to the user for each work process.

Although the embodiment of the present invention has been described above, the technical scope of the present invention is not limited to the above embodiment. For example, the information stored in the storage unit 450 may be managed in an external server connected to the management device 400 to be communicable with each other. The server may be a so-called local server, or may be a virtual server (for example, a cloud server) constructed using resources on a network, or the like.

In addition, the processing executed by the management device 400 may be executed by an external device such as a smartphone, a PC, or a server. Each functional configuration shown in FIG. 4 may be provided in an external device, and each function may also be distributed and executed across a plurality of devices, servers, or the like. In a case where each function is distributed and executed by the plurality of devices, servers, or the like, any device may execute any processing.

For example, the user may be managed by an external PC, a server, a cloud system, or the like, and the ID of the user and the level of the user may be queried from the external device in a case where the user logs in to the injection molding machine 10. In addition, the user may log in using an external device such as a PC. In this case, the user may be managed by a server, a cloud system, or the like, and the ID of the user and the level of the user may be queried from a server, a cloud system, or the like at the time of logging in to the user's PC or the like. In addition, in this case, for example, the level of the user who has logged in, information to be provided to the user, or the like is transmitted from the external device to the injection molding machine 10.

In addition, it is clear from the description of the claims that those in which two or more of the above embodiments are combined or those in which various changes or improvements are made to the above embodiments are also included in the technical scope of the present disclosure.

It should be understood that the invention is not limited to the above-described embodiment, but may be modified into various forms on the basis of the spirit of the invention. Additionally, the modifications are included in the scope of the invention.

What is claimed is:

1. A management device comprising:
a management unit that manages a user who uses a molding device by using a first management method of managing a level of the user based on a role and a second management method of managing the level of the user based on a skill level of work.

2. The management device according to claim 1,
wherein the management unit manages an operation authority of the user for the molding device by using the first management method and the second management method.

3. The management device according to claim 1,
wherein the skill level of the work is used as an index for determining information of advice to be provided to the user.

4. The management device according to claim 1,
wherein the management unit manages the user in the second management method based on a skill level related to setting of a molding condition.

5. The management device according to claim 4,
wherein the level of the user is determined and managed based on a time required for setting the molding condition or a screen to be checked when the molding condition is set.

6. The management device according to claim 1,
wherein the management unit manages the user in the second management method based on a skill level related to maintenance of the molding device.

7. The management device according to claim 6,
wherein the level of the user is determined and managed based on a time required for the maintenance of the molding device or a screen to be checked during the maintenance.

8. The management device according to claim 1,
wherein the management unit manages the user in the second management method based on a skill level related to setup of the molding device.

9. The management device according to claim 8,
wherein the level of the user is determined and managed based on a time required for the setup of the molding device or a screen to be checked during the setup.

10. The management device according to claim 1,
wherein the management unit manages the user for each work process performed by the user in the second management method.

11. The management device according to claim 1,
wherein the level of the user is used to determine a function or information of advice to be provided to the user.

12. The management device according to claim 1,
wherein the level of the user based on the role is not managed for each work process, and the level of the user based on the skill level of the work is managed for each work process.

13. The management device according to claim 1,
wherein the level of the user based on the role is a level determined according to a job title or a process for which the user is responsible.

14. The management device according to claim 1,
wherein the level of the user based on the skill level of the work is a level indicating a degree of skill and understanding of the user in the work to be performed.

15. A management device comprising:
a management unit that manages a user who uses a molding device according to a level of the user for each work process performed by the user.

16. The management device according to claim 15,
wherein the level is an index indicating a skill level of the work.

17. A molding machine comprising:
the management device according to claim 1; and
the molding device.

18. A molding system comprising:
a management unit that manages a user who uses a molding device by using a first management method of managing a level of the user based on a role and a second management method of managing the level of the user based on a skill level of work.

19. A molding system comprising:
a management unit that manages a user who uses a molding device according to a level of the user for each work process performed by the user.
